(19) United States
(12) Patent Application Publication
(10) Pub. No.: US 2017/0220282 A1
(43) Pub. Date: Aug. 3, 2017

(54) DYNAMIC CAPACITY EXPANSION OF RAID VOLUMES

(71) Applicant: Dell Products L.P., Round Rock, TX (US)

(72) Inventors: Sanjeev S. Dambal, Austin, TX (US); Satyajit Dipakbhai Desai, Round Rock, TX (US); Somenath Das, Austin, TX (US); Piyush Sharma, Round Rock, TX (US)

(73) Assignee: Dell Products L.P., Round Rock, TX (US)

(21) Appl. No.: 15/010,469

(22) Filed: Jan. 29, 2016

(51) Int. Cl. G06F 3/06

(52) U.S. Cl. CPC G06F 3/0631; G06F 3/0604; G06F 3/0689

(57) ABSTRACT

A method of operating a redundant array of independent drives (RAID) includes obtaining, by a remote access controller, a utilization threshold and an expansion factor corresponding to a RAID volume comprising a set of existing storage drives. An indication of a utilization event indicative of a utilization of the RAID volume exceeding the utilization threshold may be received and an indication of additional capacity requested may be identified. Responsive to determining that the RAID volume has un-allocated capacity at least equal to the additional capacity, the RAID volume may be reconfigured using the existing storage drives. Responsive to determining that the RAID volume lacks un-allocated capacity greater than or equal to the additional capacity, the RAID volume may be reconfigured by identifying compatible storage drives comprising available storage drives compatible with the existing storage drives and reconfiguring the RAID volume to include a particular compatible storage drive.

### TECHNICAL FIELD

The present disclosure generally relates to data storage systems and in particular to a method of implementing a redundant array of independent drives (RAID) storage system.

### BACKGROUND

As the value and use of information continue to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. Accordingly, information handling systems may be general or configured for a specific user or specific use such as financial transaction processing, airline reservations, enterprise data storage, or global communications. In addition, an information handling system may include a variety of hardware and software components that may be configured to process, store, and communicate information and may include one or more computer systems, data storage systems, and networking systems.

An information handling system can be configured in several different configurations. The information handling system can range from a single, stand-alone computer system to a distributed, multi-device computer system, to a networked computer system with remote or cloud storage systems. Both local computer storage systems and remote or cloud storage systems can employ redundant arrays of independent drives (RAID) using ferromagnetic disk drives or solid state storage drives. Various “levels” of RAID configurations are well known to those in the field of data storage systems.

Regardless of the particular RAID configuration employed, the storage capacity may need to be expanded from time to time. Conventional capacity expansion methods for RAID-based storage systems generally require end user intervention to trigger an expansion operation. For example, it may be necessary for the customer or other end user to monitor the storage capacity utilization of a RAID volume in order to prevent data loss that could occur due to space limitations on the volume.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an example information handling system (IHS) within which various aspects of the disclosure can be implemented, according to one or more embodiments;

FIG. 2 illustrates a block diagram of an example storage system, in accordance with one or more embodiments;

FIG. 3 illustrates elements of a dynamic capacity expansion method;

FIG. 4 illustrates further elements of a dynamic capacity expansion method; and

FIG. 5 illustrates information handling system elements communicating to implement a dynamic capacity expansion of a RAID volume.

### SUMMARY

Data storage methods disclosed herein may include receiving a utilization message indicating that the utilization of a RAID volume corresponding to a particular set of storage drives equals or exceeding a utilization threshold. An indication of desired additional capacity associated with the utilization message may be accessed and, responsive to determining that the RAID volume has free capacity greater than or equal to the desired additional capacity, the desired additional capacity with the existing storage drives may be provided by re-configuring the existing set of storage drives to expand the capacity of the RAID volume in accordance with the desired additional capacity.

If, however, it is determined that the RAID volume lacks free capacity greater than or equal to the desired additional capacity, the method may attempt to satisfy the desired additional capacity by incorporating one or more additional storage drives into the RAID volume. This feature of the method may include filtering unallocated or otherwise free storage drives according to a particular set of storage drive parameters to identify those available storage drives that are also compatible with the particular set of storage drives in the RAID volume.

Upon identifying one or more compatible storage drives, a determination of whether the volume span depth and volume span width limits associated with the RAID volume permit or preclude additional storage drives may be made. If additional storage drives are permitted, the method may include adding at least one of the compatible storage drive(s) to the RAID volume.

Compatible storage drives may refer to storage sharing one or more of the following storage drive features or characteristics in common: media type, e.g., HDD vs. SSD, storage protocol, e.g., SAS vs. SATA, a self-encryption characteristic, and a block size characteristic. In some embodiments, a compatible storage drive may share all of these characteristics in common with the particular storage drives in the RAID volume.

Available storage drives may also be filtered based upon storage capacity. For examples, available storage drives that are smaller, i.e., have less storage capacity, than the smallest storage drive in a RAID volume may be filtered out as in-compatible. In conjunction with the storage capacities of the existing storage drives and the available and otherwise compatible storage drives, adding an additional storage drive to the RAID volume may include adding a compatible storage drive having the smallest capacity that is equal to or greater than a capacity of the smallest drive in the particular set of storage drives.

Additional compatible storage drives, beyond the first compatible storage drive, may be added to the RAID volume until the RAID volume achieves additional capacity equal to or greater than the desired additional capacity, volume span limits associated with the RAID volume preclude adding an additional storage drive to the RAID volume, or no compatible storage drives remain available.

In some embodiments, the desired additional capacity may be calculated from the existing capacity and an expansion factor by accessing the expansion factor and determining the desired additional capacity, based on the product of the expansion factor and the existing capacity of the RAID volume.

After a RAID volume expansion is performed, a corresponding file system expansion may be performed to enable a host's operating system and application programs to utilize the additional capacity achieved.

In another respect, information handling systems disclosed herein may include a processor and a memory medium, accessible to the processor, including processor executable instructions such as an operating system and application programs. The IHS may further include a storage subsystem, including a storage controller and storage media, as well as a dynamic capacity expansion (DCE) module configured to perform storage configuration operations that include receiving a request to perform dynamic capacity expansion, the request including data indicative of a logical unit associated with the request, identifying a RAID volume associated with the logical unit, the RAID volume including a particular set of storage drives, and determining, based at least in part on existing capacity of the RAID volume, desired additional capacity. Responsive to determining that the RAID volume has free capacity greater than or equal to the desired additional capacity, the particular set of storage drives may be re-configured to expand the capacity of the RAID volume in accordance with the desired additional capacity. If the RAID volume lacks free capacity greater than or equal to the desired additional capacity, additional storage drives may be incorporated in the RAID volume by identifying compatible storage drives and verifying that the number of storage drives in the existing RAID volume does not preclude the use of any additional storage drives.

Dynamic capacity expansion as disclosed herein may include invoking a file system API to determine a file system utilization associated with a particular file system and obtaining vital product data from a port driver associated with the file system when the file system utilization exceeds a utilization threshold or limit. The DCE module may resides on a remote access controller of the information handling system wherein the remote access controller is configured to execute the DCE module and reconfigure the RAID volume. Responsive to completing a dynamic expansion of the RAID volume, a file system expansion may be initiated to enable the operating system and application programs to utilize additional capacity corresponding to the additional storage drive.

In still another aspect, a disclosed non-transitory computer readable medium may include DCE instructions that, when executed by a processor, cause the processor to perform any one or more of the following operations: receiving a request to perform dynamic capacity expansion, identifying a RAID volume associated with the request, the RAID volume comprising a particular set of storage drives, determining a desired additional capacity, and determining whether the RAID volume has sufficient free capacity including free capacity greater than or equal to the desired additional capacity. Responsive to determining that the RAID volume has sufficient free capacity, the particular set of storage drives may be re-configured to expand the capacity of the RAID volume in accordance with the desired additional capacity.

Responsive to determining that the RAID volume lacks sufficient free capacity, operations for expanding the capacity of the RAID volume with one or more additional storage drives may be performed. Additional storage drives may be added to the RAID volume subject to volume span limits associated with the RAID volume and the availability of compatible storage drives. Compatible storage drives may include storage drives that share one or more of the following storage drive features in common with the RAID volume storage drives: a media type, a storage protocol, a self-encryption feature, and a block size. To achieve storage efficiency, embodiments may filter the compatible storage drives according to size, i.e., storage capacity, and select the smallest compatible storage drive that is consistent with the storage drives in the existing RAID volume. In at least one embodiment, this process selects the compatible storage drive that equals or exceeds the size of the smallest storage drive in the existing RAID volume. For example, if a RAID 5 volume spanning 3 storage drives includes a 100 GB drive and two 80 GB drives and the set of compatible storage drives includes a 75 GB drive, a 90 GB drive, and a 110 GB drive, the 90 GB drive would be selected as the smallest compatible drive having a capacity greater than the capacity of the smallest drive in the RAID volume, 80 GB.

The above summary is not intended as a comprehensive description of the claimed subject matter but, rather, is intended to provide an overview of the applicable subject matter. Other methods, systems, software, functionality, features and advantages of the claimed subject matter will be or will become apparent to one with skill in the art upon examination of the following figures and detailed written description.

### DETAILED DESCRIPTION

In the following detailed description of exemplary embodiments, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “at least one embodiment”, or “some embodiments” and the like indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not for other embodiments.

It is understood that the use of specific component, device, and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

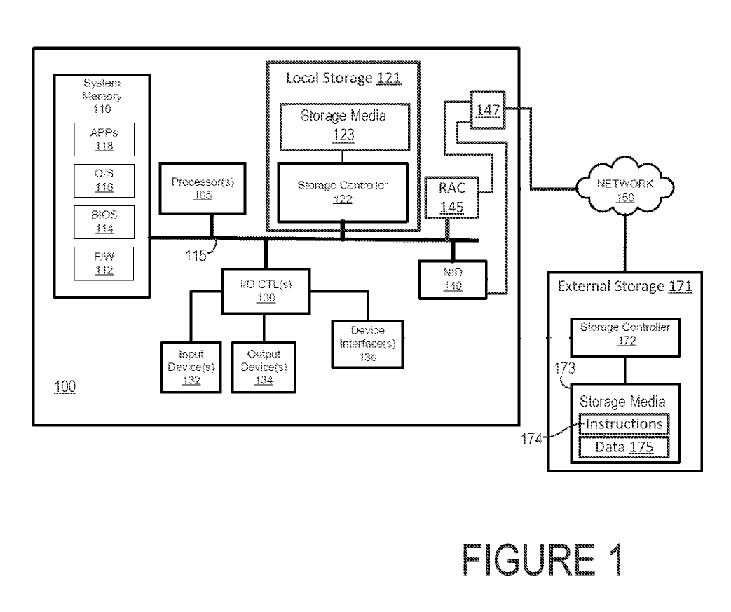

FIG. 1 illustrates a block diagram representation of an example information handling system (IHS) 100, within which any one or more described features of the various embodiments of the disclosure can be implemented. For purposes of this disclosure, an IHS, such as IHS 100, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a handheld device, a personal computer, a server, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices, as well as various input and output (I/O) devices, such as a keyboard, a mouse, and a video display. The IHS may also include one or more buses operable to transmit communications between the various hardware components.

Referring specifically to FIG. 1, example IHS 100 includes one or more processor(s) 105 coupled to a system memory 110 via a system interconnect 115, which may also be referred to herein as system bus 115. The system memory 110 illustrated in FIG. 1 stores processor-executable instructions for various modules including firmware (F/W) 112, basic input/output system (BIOS) 114, operating system (0/S) 116 and application(s) 118. The IHS 100 illustrated in FIG. 1 includes local storage 121, including a storage controller 122 coupled between system bus 115 and storage media 123, within which can include stored data, software, and/or firmware (not specifically shown).

The IHS 100 illustrated in FIG. 1 further includes one or more input/output (I/O) controllers 130 coupling various I/O devices and corresponding I/O device signals to processors 105 via system bus 115. FIG. 1 illustrates the various I/O devices as input devices 132, output devices 134, and device interfaces 136. Input devices 132 may include, as non-limiting examples, a keyboard, mouse, touch screen, or microphone. Output devices 134 may include, as non-limiting examples, a monitor, display device, speaker(s), and printer(s). The interface(s) 136 illustrated in FIG. 1 may include interfaces for coupling processor(s) 105 and/or system bus 115 to various devices including, as non-limiting examples, an optical reader, a universal serial bus (USB), a card reader, a Personal Computer Memory Card International Association (PCMCIA) slot, and/or a high-definition multimedia interface (HDMI). Device interface(s) 136 may also include one or more interfaces enabling IHS 100 to read data from or store data to removable storage device(s), including, as non-limiting examples, a compact disk (CD), digital video disk (DVD), flash drive, or flash memory card. In at least one embodiment, device interface(s) 136 may further include general purpose I/O interfaces such as I2C, SMBus, and peripheral component interconnect (PCI) buses.

The IHS 100 illustrated in FIG. 1 includes a network interface device (NID) 140 that enables IHS 100 to communicate and/or interface with devices, systems, and services via an external network 150 using one or more communication protocols. Network 150 can include one or more personal area network components, local area network components, wide area network components, or a combination thereof. Any connection to IHS 100 that traverses network 150 can include one more wireline segments, one or more wireless components, or a combination thereof. For purposes of discussion, network 150 is indicated as a single collective component for simplicity. However, it is appreciated that network 150 can comprise one or more direct connections to other devices as well as a more complex set of interconnections as can exist within a wide area network, such as the Internet.

The network 150 illustrated in FIG. 1 provides IHS 100 with access to external storage 171, which includes a storage controller 172 coupled to storage media 173 within which can be stored processor-executable instructions 174, which can include application program instructions, firmware instructions, or a combination thereof, and one or more sets of data 175. Storage media 173 can include a plurality of hard disk drives, solid state storage drives, or other storage media. In at least one embodiment, external storage 171 includes one or more RAID volumes. While FIG. 1 illustrates external storage 171 coupled to IHS 100 via network 150, external storage 171 may be directly connected to IHS 100 as an external storage device.

Local storage 121 and external storage 171 represent persistent storage, i.e., storage media that retains data through one or more power cycles. Although FIG. 1 illustrates information handling system 100 with both local storage 121 and external storage 171, other embodiments may omit local storage 121 while still other embodiments may omit external storage 171.

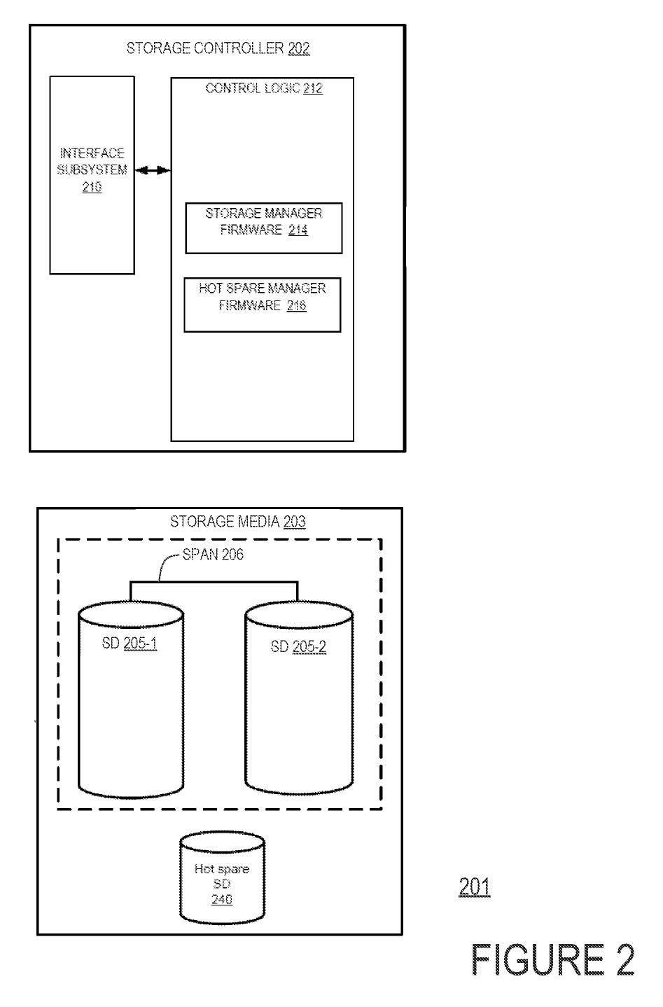

Local storage 121 and external storage 171 are both illustrated including a storage controller and the corresponding storage media. The local storage controller 122 and the external storage controller 172 may implement analogous functionality, including functionality described below with respect to a generic storage controller illustrated in FIG. 2.

The information handling system 100 illustrated in FIG. 1 includes a remote access controller 145 providing a first input to a network switch 147 that receives a second input from the network interface device 140. In this embodiment, information handling system 100 may communicate with network 150 from either the RAC 145 or via NID 140, depending upon switch 147. In other embodiments, RAC 145 and an NID 140 may both have their own resources for connecting to network 150 and network switch 147 may be omitted. In still other embodiments, RAC 145 and NID 140 may share the connection to network 150, possibly using distinct hardware addresses to distinguish between the two devices.

In the embodiment illustrated in FIG. 1, the remote access controller 145 represents a resource for externally managing and configuring information handling system 100. Remote access controller 145 may enable functionality that facilitates deployment, updating, monitoring, and maintenance of information handling system 100 with or without a systems management software agent resident. In at least one embodiment, remote access controller 145 provides out of band control over configuration of information handling system 100, thereby streamlining local and remote server management and reducing or eliminating the need for system administrators to physically visit a system even if the system is not itself operational. Remote access controller 145 may support or exhibit functionality analogous to functionality provided by an integrated remote access controller(iDRAC) from Dell, Inc.

With reference now to FIG. 2, a storage system 201 may represent local storage 121 (FIG. 1), external storage 171 (FIG. 1), or both and may be configured to store data, software instructions, firmware instructions, or a combination thereof.

The storage system 201 illustrated in FIG. 2 includes a storage controller 202 and storage media 203. Storage controller 202 may be configured to control and manage the flow of commands and data to and from storage media 203. The storage media 203 may include two or more storage drives (SDs) 205 configured as a storage entity referred to herein as RAID span 206. The RAID span 206 illustrated in FIG. 2 includes two storage drives, 205-1 and 205-2, however other embodiments may include three or more storage drives 205. The relationship between data stored in the individual storage drives 205 of any RAID span 206 depends, at least in part, upon the RAID level of RAID span 206. For example, in a RAID 1 embodiment of RAID span 206, the data on storage drive 205-1 is copied or mirrored on storage drive 205-2. A RAID 5 embodiment of RAID span 206 may include three or more storage drives 205 wherein a data block is striped across two or more of the storage drives and parity information is generated and stored on one of the storage drives.

The storage media 203 illustrated in FIG. 2 further includes a hot spare storage drives 240. Hot spare storage drive 240 is a storage drive that may be used to replace a failing or failed storage drive in a RAID system. The presence of an available hot spare storage drive 240 within storage media 203 may reduce recovery time when a storage drive 205 employed in RAID span 206 fails.

The storage controller 202 illustrated in FIG. 2 may be configured to read and write to RAID span 206 in storage media 203. The illustrated storage controller 202 include an interface subsystem 210 and control logic 212. Interface subsystem 210 may manage communications between control logic 212 and IHS 100 (FIG. 1).

Storage manager firmware 214 may group storage drives 205 into one or more RAID volumes and may be configured to manage the reading and writing of data to storage media 203 in compliance with a particular RAID level to improve storage reliability and/or storage read/write performance. Hot spare manager firmware 216 may manage the rebuilding of data in hot spare storage drive 240 when one or more storage drives 205 in storage media 203 fail.

Control logic 212 may include functional modules or processes including storage manager firmware 214 and hot spare manager firmware 216. Each of the storage controller components may include the ability to communicate with each other via a communication fabric, which may represent particular messaging signals communicated over particular signal lines (not illustrated in FIG. 2). At least some functions, modules, routines, methods and processes disclosed herein, including automated capacity expansion methods, may be implemented as executable code and/or logic within storage controller 202.

Those of ordinary skill in the art will appreciate that the hardware components and basic configuration depicted in FIGS. 1 and 2 and described herein may vary. For example, the components within IHS 100 (FIG. 1) are not intended to be exhaustive, but rather are representative to highlight components that can be utilized to implement aspects of the present disclosure. For example, other devices/components may be used in addition to or in place of the hardware depicted. The depicted examples do not convey or imply any architectural or other limitations with respect to the presently described embodiments and/or the general disclosure.

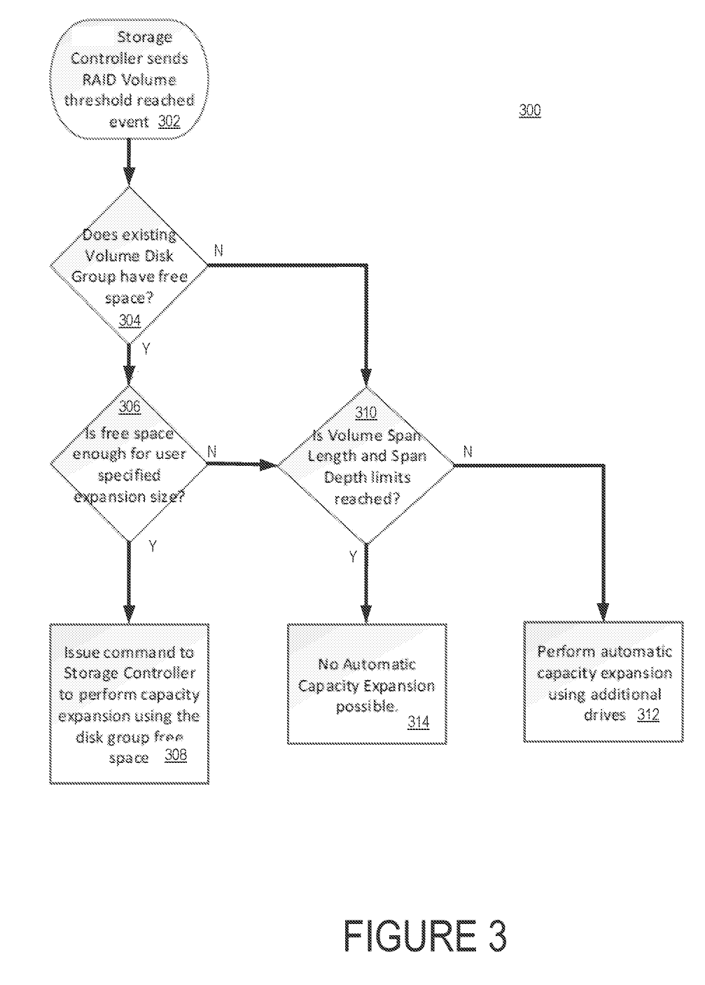

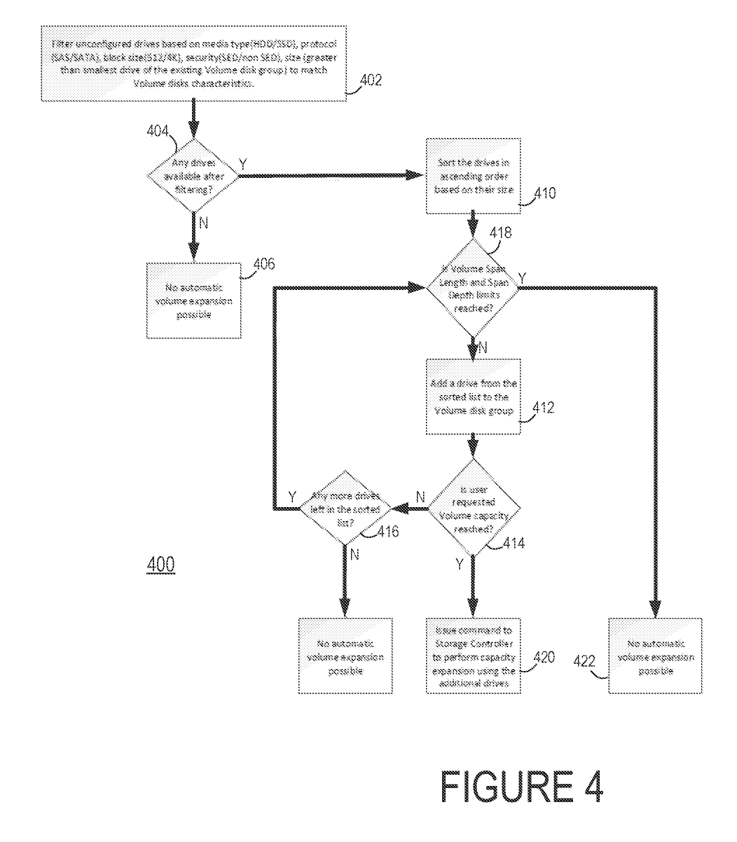

FIG. 3 and FIG. 4 illustrate example methods for implementing automated capacity expansion, sometimes referred to herein as dynamic capacity expansion (DCE), including automated capacity expansion of a RAID volume. In at least one embodiment, prior to performing operational elements of the methods illustrated in FIG. 3 and FIG. 4, a pair of DCE configuration attributes are specified, determined, obtained, or otherwise accessed. A first DCE configuration attribute, referred to herein as the volume utilization threshold, indicates a threshold value for a utilization parameter. The volume utilization threshold may indicate a utilization value at or above which DCE may be triggered. For example, an administrator may stipulate that DCE kicks in when 90% of a particular volume has been utilized by specifying 90% as the volume utilization threshold. A second DCE attribute, referred to herein as the expansion factor, may determine or otherwise convey the amount of additional capacity desired when DCE is invoked. The expansion factor may be specified as a percentage and the desired additional capacity may refer to the specified percentage of the current capacity of a RAID volume. For example, an administrator may specify an expansion factor of 10% to indicate that additional capacity equal to 10% of the existing capacity is desired each time DCE is triggered.

At least some of the operations described with respect to FIG. 3 and FIG. 4 may be performed in the context of an IHS 100 that includes external storage such as the external storage 171 illustrated in FIG. 1. In any of these embodiments, any one or more of the operations represented in FIG. 3 and FIG. 4 may be performed by or in conjunction with one or more elements of IHS 100. As one non-limiting example, the remote access controller 145 of IHS 100 may be in communication with external storage 171 via network 150 and may perform one or more operations to implement, facilitate, or support DCE of external storage 171. Similarly, in embodiments of IHS 100 that may lack an external storage resource, the remote access controller 145 may communicate with storage controller 122 of local storage 121 to implement DCE.

FIG. 3 illustrates a capacity expansion method 300 that may be executed when the volume utilization threshold specified in the configuration setting described above is reached. Volume utilization monitoring may be performed by the storage controller 202 (FIG. 2), remote access controller 145 of FIG. 1, or another element of IHS 100.

The method 300 illustrated in FIG. 3 begins with the sending (block 302) of a utilization threshold event message indicating that the utilization of the existing RAID volume has reached or exceeded the volume utilization threshold. In one embodiment, the storage controller 202 (FIG. 2) may perform the monitoring of the applicable RAID span 206. Storage controller 202 may communicate the utilization threshold event message to the remote access controller 145, thereby enabling DCE without regard to whether processor 105 and system memory 110 are in an operational state.

The utilization threshold event may trigger a determination of the additional capacity desired. In at least one embodiment, the expansion factor parameter indicates a percentage and the desired additional capacity is computed as the product of the existing capacity and expansion factor. In other embodiments, the desired additional capacity may be a particular amount of additional capacity that does not change as a function of the existing capacity or that changes in a non-linear way.

A DCE module within remote access controller 145 may respond to the utilization threshold event by determining (operation 304) whether the existing storage drives 205 of the RAID span 206 that triggered the utilization threshold event have any free storage space. If there is any free space available, the DCE module may determine (operation 306) whether the storage space that is available equals or exceeds the desired additional capacity. If the free space available on the existing drives 205 of the RAID span 206 equals or exceeds the desired additional capacity, the DCE module may issue (operation 308) a capacity expansion command instructing the storage controller to re-configure the existing storage drives 205 of the RAID span 206 to capture at least some of the unallocated storage available on the existing storage drives. The amount of available storage that the storage controller captures during this reconfiguration may be equal to the desired additional capacity.

If the DCE module determines, during operation 304, that the existing storage drives 205 have no free space available or determines, during operation 306, that the existing storage drives 205 do not have free space equal to or exceeding the desired additional capacity, the DCE module may determine (operation 310) whether the existing RAID span 206 has reached its maximum span length or maximum span depth. If at least one of the span length and span depth of the existing RAID span 206 is less than the maximum span length, the DCE module may then proceed (operation 312) to determine whether the capacity of the existing RAID span 206 might be increased using one or more additional storage drives according to a method described below with respect to FIG. 4. On the other hand, if the RAID span 206 is already at its maximum span depth and length, the DCE module concludes (operation 314) that no capacity expansion is possible.

To perform volume expansion with additional drives as illustrated in FIG. 4, the DCE module may determine whether there are any available storage drives by first filtering (operation 402) the population consisting of all available storage drives according to a number of compatibility criteria or parameters to identify any available storage drives that are compatible with the existing storage drives 205 of the RAID span 206. In at least one embodiment, the available drives may be filtered based on compatibility parameters including, as non-limiting examples, storage media type, granularity or block size, e.g., 512 v. 4K block sizes, storage protocol, e.g., SATA protocol, SAS protocol, etc., security, (e.g., self-encrypting device (SED) vs. non-SED), and device size, i.e., capacity. The filtering of operation 402 may be done to select only those drives that are compatible with the storage drives 205 of the existing RAID span 206.

After filtering the available storage drives to identify available and compatible storage drives, the DCE module may then determine (block 404) whether there are any compatible storage drives available to participate in capacity expansion. If the DCE modules determines, in operation 404, that there are no available and compatible storage drives, the DCE module terminates (operation 406) because capacity expansion is not possible.

Once any compatible drives have been identified by the filtering, the DCE module may begin the process of identifying particular drives to use in the capacity expansion by sorting (block 410) the drives in an ascending order based on capacity size. In at least one embodiment, the best drive to provide additional storage is a drive that has just enough storage to satisfy the expansion request. After sorting the available and compatible drives according to their size, the DCE module may begin a loop in which available and compatible storage drives are added incrementally until either the additional desired capacity is achieved or the RAID span equals or exceeds one or both of its depth thresholds.

The method 400 illustrated in FIG. 4 thus includes a determination (operation 418) of whether the volume span length and depth limits have been reached. If the span length and depth limits have been reached, method 400 terminates (operation 422) after concluding that no automatic capacity expansion is possible.

If the span depth and length limits have not been breached, the DCE module may then add (block 412) one drive at a time from the sorted list of available and compatible drives to the RAID span 206 until either: (a) the requested expansion is achieved (block 414), there are no more available and compatible drives left in the sorted list (operation 416), or a volume span length or depth limit is reached (operation 418). If method 400 determines that there are no more available drives or that a volume span length or span depth limit has been reached, then the requested expansion cannot be achieved and the method terminates. If the requested expansion is reached successfully, the administrator may issue (block 420) a command to the storage controller to perform capacity expansion using the additional drives.

The following examples assume that the administrator has specified 90% for the volume utilization threshold and 10% for the expansion percentage.

Expansion using available disk group space. Consider a system in which a 100 GB RAID 1 volume exists on two 250 GB drives. If the volume utilization reaches 90 GB (90%), the storage controller sends an event and the DCE module checks if the existing disk group has space to expand the volume to 110 GB (10% of existing volume size). Since the drives have 150 GB space available, the DCE module will trigger an expansion using 10 GB of the available 150 GB and expand the volume to 110 GB, leaving 140 GB of storage available on each drive. If the volume utilization reaches 90% a second time, the DCE module will trigger an expansion using 11 GB of the available 140 GB and expand the volume to 121 GB, leaving 129 GB of storage available on each drive. If the volume utilization reaches 90% a third time, the DCE module will trigger a third expansion using 12.1 GB of the available 129 GB and expand the volume to 133.1 GB, leaving 116.9 and so forth.

Expansion using additional drives (FIG. 4). Consider a system that has three drives of 100 GB each in a 200 GB RAID 5 volume. If the volume utilization reaches 180 GB (90%), the storage controller sends an event and the DCE module checks if the existing disk group has space to expand the volume to 220 GB (10% of existing volume size). Since the disk group does not have any free space, the DCE module will kick in and add one or more compatible drives, if any, until the entire volume can be expanded to 220 GB. For example, if there are three compatible drives, one with 70 GB of capacity, a second drive with 80 GB of capacity, and a third drive with 100 GB of capacity, the DCE module may select the 100 GB drive as the smallest compatible drive with sufficient storage to satisfy the request for 220 GB of allocated capacity. Note that in this example, although the 80 GB drive could be used to create a 240 GB RAID 5 volume on 4 drives, the 80 GB drive is considered incompatible since it is smaller than the smallest drive in the existing volume.

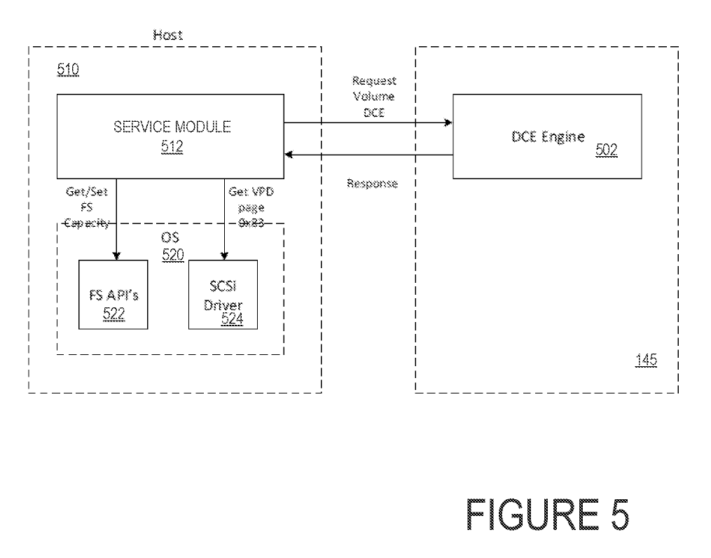

FIG. 5 illustrates interaction between a dynamic capacity expansion engine 502 of remote access controller 145 and a host system 510 to expand the capacity of the applicable RAID span and to thereafter perform file system expansion to enable the host operating system and application programs to utilize the added capacity.

As shown in FIG. 5, a service module 512 running on a host system 510 invokes file system APIs 522 to determine the current file system usage capacity. If the file system usage capacity equals or exceeds the utilization threshold, service module 512 may obtain “page 83” vital product data (VPD) from the SCSI driver 524 for the applicable file system. Service module 512 may then transfer this information to remote access controller 145. The DCE engine 502 on remote access controller 145 may then find the appropriate RAID volume using the page 83 VPD and perform the expansion of the RAID volume.

Once DCE 502 performs expansion of the RAID volume, expansion of the corresponding file system may be performed to ensure that expanded capacity can be utilized by the OS 520 and application programs. To perform the necessary file system expansion, service module 512 may be notified by DCE engine 502 when the RAID volume expansion is complete. Service module 512 may respond to the RAID volume expansion completion notification by performing the actual file system expansion using file system APIs 522.

Thus, the described processes perform dynamic capacity expansion for RAID volumes based on utilization threshold and an expansion factor and thereby reduce or eliminate the need for the customer to monitor storage capacity utilization and to intervene as needed.

Any one or more processes or methods described above, including processes and methods associated with the FIG. 3 and FIG. 4 flow diagrams, may be embodied as a computer readable storage medium or, more simply, a computer readable medium including processor-executable program instructions, also referred to as program code or software, that, when executed by the processor, cause the processor to perform or otherwise results in the performance of the applicable operations.

A computer readable medium, which may also be referred to as computer readable memory or computer readable storage, encompasses volatile and non-volatile media, memory, and storage, whether programmable or not, whether randomly accessible or not, and whether implemented in a semiconductor, ferro-magnetic, optical, organic, or other suitable medium. Information handling systems may include two or more different types of computer readable medium and, in such systems, program code may be stored, in whole or in part, in two or more different types of computer readable medium.

Unless indicated otherwise, operational elements of illustrated or described methods may be combined, performed simultaneously, or performed in a different order than illustrated or described. In this regard, use of the terms first, second, etc. does not necessarily denote any order, importance, or preference, but may instead merely distinguish two or more distinct elements.

Program code for effecting described operations may be written in any appropriate combination of programming languages and encompasses human readable program code including source code as well as machine readable code including object code. Program code may be executed by a general purpose processor, a special purpose processor, including, as non-limiting examples, a graphics processor, a service processor, or an embedded processor or controller.

Disclosed subject matter may be implemented in any appropriate combination of software, firmware, and hardware. Terms including circuit(s), chip(s), processor(s), device(s), computer(s), desktop(s), laptop(s), system(s), and network(s) suggest at least some hardware or structural element(s), but may encompass non-transient intangible elements including program instruction(s) and one or more data structures including one or more databases.

While the disclosure has been described with reference to exemplary embodiments, it will be understood by those skilled in the art that the disclosure encompasses various changes and equivalents substituted for elements. Therefore, the disclosure is not limited to the particular embodiments expressly disclosed, but encompasses all embodiments falling within the scope of the appended claims.

As used herein, the singular forms “a”, “an” and “the” are intended to include the plural forms as well, unless the context clearly indicates otherwise. It will be further understood that the terms “comprises” and/or “comprising,” when used in this specification, indicate the presence of stated features, operations, elements, and/or components, but do not preclude the presence or addition of one or more other features, operations, elements, components, and/or groups thereof.

What is claimed is:

1. A data storage method, comprising:
receiving a utilization message indicating utilization of a redundant array of independent drives (RAID) volume exceeding a utilization threshold, the RAID volume including a particular set of storage drives;
accessing an indication of desired additional capacity associated with the utilization message;
responsive to determining that the RAID volume has free capacity greater than or equal to the desired additional capacity, re-configuring the particular set of storage drives to expand the capacity of the RAID volume in accordance with the desired additional capacity; and
responsive to determining that the RAID volume lacks free capacity greater than or equal to the desired additional capacity, performing operations comprising:
filtering available storage drives in accordance with a particular set of storage drive parameters to identify compatible storage drives comprising available storage drives compatible with the particular set of storage drives; and
responsive to determining that volume span depth and volume span width limits associated with the RAID volume do not preclude adding an additional storage drive, adding to the RAID volume at least one additional storage drive to the RAID volume.

2. The method of claim 1, wherein filtering the available storage drives includes filtering out available storage drives having a different media type than the particular set of storage drives.

3. The method of claim 1, wherein filtering the avaiable storage drives includes filtering out available storage drives employing a different storage protocol than the particular set of storage drives.

4. The method of claim 1, wherein filtering the avaiable storage drives includes filtering out available storage drives having a different self-encryption characteristic than the particular set of storage drives.

5. The method of claim 1, wherein filtering the available storage drives includes filtering out available storage drives configured having a different block size than the particular set of storage drives.

6. The method of claim 1, wherein filtering the available storage drives includes filtering out available storage drives having a capacity less than the capacity of the smallest storage drive in the particular set of storage drives.

7. The method of claim 1, further comprising:
sorting the compatible storage drives according to storage capacity, wherein adding the at least one additional storage drive to the RAID volume includes adding a compatible storage drive having the smallest capacity that is equal to or greater than a capacity of the smallest storage drive in the particular set of storage drives.

8. The method of claim 1, further comprising repeating the adding of at least one additional storage drive until:
the RAID volume achieves additional capacity equal to or greater than the desired additional capacity;
volume span limits associated with the RAID volume preclude adding an additional storage drive to the RAID volume; or
no compatible storage drives are available.

9. The method of claim 1, wherein accessing the desired additional capacity includes:
accessing an expansion factor associated with the RAID volume; and
determining the desired additional capacity, based on the product of the expansion factor and the existing capacity of the RAID volume.

10. The method of claim 1, further comprising:
responsive to completion of the adding of the additional storage drive to the RAID volume, initiating a file system expansion to enable an operating system and application programs to utilize additional capacity corresponding to the additional storage drive.

11. An information handling system comprising:
a processor;
a memory medium, accessible to the processor, including processor executable instructions;
a storage subsystem including a storage controller and storage media; and
a dynamic capacity expansion (DCE) module configured to perform storage configuration operations including:
receiving a request to perform dynamic capacity expansion, the request including data indicative of a logical unit associated with the request;
identifying a redundant array of independent drives (RAID) volume associated with the logical unit, the RAID volume including a particular set of storage drives;
determining, based at least in part on existing capacity of the RAID volume, desired additional capacity;
responsive to determining that the RAID volume has free capacity greater than or equal to the desired additional capacity, re-configuring the particular set of storage drives to expand the capacity of the RAID volume in accordance with the desired additional capacity; and
responsive to determining that the RAID volume lacks free capacity greater than or equal to the desired additional capacity, performing operations comprising:
identifying, from a set of available storage drives, compatible storage drives in accordance with a particular set of storage drive parameters; and
responsive to determining that volume span depth and volume span width limits associated with the RAID volume do not preclude adding an additional storage drive, adding to the RAID volume at least one additional storage drive to the RAID volume.

12. The information handling system of claim 11, wherein the operations include:
invoking a file system API to determine a file system utilization associated with a particular file system; and
responsive to the file system utilization exceeding a utilization limit, obtaining vital product data from a port driver associated with the file system.

13. The information handling system of claim 11, wherein identifying the compatible storage drives includes filtering the compatible storage drives in accordance with storage drive parameters including: a media type parameter, a storage protocol parameter, a self-encryption parameter, a block size parameter, and a capacity parameter.

14. The information handling system of claim 11, wherein the DCE module resides on a remote access controller of the information handling system, wherein the remote access controller is configured to execute the DCE module and reconfigure the RAID volume.

15. The information handling system of claim 11, wherein the operations include:
responsive to completion of the adding of the additional storage drive to the RAID volume, initiating a file system expansion to enable an operating system and application programs to utilize additional capacity corresponding to the additional storage drive.

16. A non-transitory computer readable medium comprising processor executable dynamic capacity expansion (DCE) instructions that, when executed by a processor, cause the processor to perform operations including:
receiving a request to perform dynamic capacity expansion;
identifying a redundant array of independent disks (RAID) volume associated with the request, the RAID volume comprising a particular set of storage drives;
determining a desired additional capacity;
determining whether the RAID volume has sufficient free capacity including free capacity greater than or equal to the desired additional capacity;
responsive to determining that the RAID volume has sufficient free capacity, re-configuring the particular set of storage drives to expand the capacity of the RAID volume in accordance with the desired additional capacity;
responsive to determining that the RAID volume lacks sufficient free capacity, determining:
whether the RAID volume may be reconfigured to include an additional storage drive; and
whether storage drives available for adding to the RAID volume include any compatible storage drives, wherein a compatible storage drive comprises a storage drive having a particular set of storage drive features in common with the particular set of storage drives in the RAID volume; and
responsive to determining that the RAID volume permits the addition of at least one additional storage drive and that the available storage drives include at least one compatible storage drive, performing expansion operations including:
adding an additional storage drive in the RAID volume and reconfiguring the RAID volume to reflect additional capacity corresponding to the additional storage drive.

17. The non-transitory computer readable medium of claim 16, wherein the expansion operations include:
expanding a capacity of a file system associated with the RAID volume.

18. The non-transitory computer readable medium of claim 17, wherein the operations include:
repeating the expansion operations until a termination criteria is met, wherein the termination criteria is selected from the group comprising:
the desired additional storage capacity is achieved;
the RAID volume does not permit the inclusion of any additional storage drives; and
no compatible storage drives remain.

19. The non-transitory computer readable medium of claim 16, wherein compatible storage drives share at least the following storage drive features in common with the RAID volume storage drives: a media type, a storage protocol, a self-encryption feature, and a block size.

20. The non-transitory computer readable medium of claim 19, wherein compatible storage drives have a storage capacity greater than or equal to the smallest of the particular set of storage drives in the RAID volume.
